(19) United States
(12) Patent Application Publication
(10) Pub. No.: US 2010/0192203 A1
(43) Pub. Date: Jul. 29, 2010

(54) CONTENT DISTRIBUTION WITH INHERENT USER-ORIENTED AUTHORIZATION VERIFICATION

(76) Inventor: Matthias Roebke, Koeln (DE)

Correspondence Address: KF ROSS PC, 5683 RIVERDALE AVENUE, SUITE 203 BOX 900, BRONX, NY, 10471-0900, US

(21) Appl. No.: 12/676,037

(22) PCT Filed: Jul. 25, 2008
(86) PCT No.: PCT/EP2008/006134

§ 371 Date: Apr. 1, 2010

(30) Foreign Application Priority Data
Oct. 5, 2007 (DE) 10 2007 048 044.1

(51) Int. Cl. H04L 29/06

(52) U.S. Cl. 726/4

(57) ABSTRACT

The invention relates to a method for verifying the use authorization of an access to a communications service (1), particularly to media content, wherein the communications service (1) is usable by means of a terminal device (2) via wireless or fixed network, wherein a verification query is generated by the communications service (1) and transmitted to the terminal device (2) and a verification process is initiated on the terminal device (2) in which the use authorization is verified by means of a verification instance (3) and the verification instance (3) generates a corresponding notification after verification of use authorization and said notification is directly or indirectly transmitted to the communications service (1).

The invention relates to a method of and system for verifying the use authorization for access to a communications service, in particular to media content, where the communications service is usable via mobile telephone network or fixed telephone network having a corresponding communications terminal device.

According to the prior art, it is possible today to distribute content, i.e. media content via the Internet, such as images, data, and the like, both through fixed networks and also mobile telephone networks. A differentiation is made here between two different types of distribution: discrete media types (characterized by completed objects, that is files that are characterized by a fixed file size), such as those found for example in messaging services like email, SMS, MMS, etc., and continuous media that are found in streaming services. These types of multimedia content will also be found in future-generation messaging systems, such as for example in “convergent messaging systems” as defined by the Open Mobile Alliance (OMA).

With today's state of the art, it is not possible to effect automatic user verification, in particular age verification, either in conventional messaging systems (such as for example MMS, SMS, email) or in convergent messaging systems. Age verification is used, for example, to check whether the receiver is old enough to be permitted to use the content so as to protect young recipients from content harmful to minors.

It is the object of this invention is to provide a system and method that enable an inherent user verification to be provided, in particular age verification in communications services (both for conventional services such as SMS, MMS, Instant Messaging, as well as for future alternative services, such as for example convergent messaging systems), when accessing media content that is offered, for example, on the Internet.

This problem is solved by a method according to claim 1.

What is especially advantageous here is that in the system or method of verifying user authorization for access to a communications service, in particular media content, where the communications service is usable by a terminal device via a mobile telephone network and/or fixed telephone network, a verification query is generated by the communications service and transmitted to the terminal device, and a verification process is initiated by the terminal device, in which process the use authorization is verified by the verification entity, and that the verification entity, after examining the use authorization, generates an appropriate message and transmits this message directly or indirectly to the communications service.

As a result, a verification of the use authorization is initiated automatically by the user's accessing certain communications services.

The specific communications service can be a computer network, such as the Internet or an intranet, but alternatively may also be any other type of information or media service.

The specific terminal device can be a mobile telephone terminal device, but, on the other hand, can also be a terminal device for fixed-network communication, for example, a PC. Fundamentally, the present invention is applicable to communications services within any given communications network having stationary or mobile telephone terminal devices.

Through use of a verification entity that does an examination of the use authorization, the user, however, cannot manipulate, or can manipulate only with disproportionately high technical input, this verification entity or associated communications process and verification of the use authorization is possible with a very high level of reliability. Generation of the verification query here by the communications service is carried out automatically with every attempt to access the protected data and/or protected services.

Additional advantageous embodiments of the invention are provided in the dependent claims.

In a preferred embodiment, the verification entity verifies the use authorization by querying the SIM or the USIM of the terminal device. This provides the system with a very high level of reliability and security since a disproportionately high effort would be required to manipulate the SIM or USIM of the terminal device. The data required for verification, such as, for example, the user's date of birth, are stored for this purpose on the SIM/USIM and are read and transmitted to the verification entity.

The verification entity is preferably located outside the terminal device, in particular on an external data-processing system. The verification entity can thus, for example, be located on an external web server.

Alternatively, the verification entity can be located in a protected area of the terminal device to which the user does not have access.

This then prevents the user of the communications service from being able to manipulate the verification entity.

What is preferably carried out either before or after verification of the use authorization is a user authentication—in particular by requesting a personal identification number (PIN) and/or by collecting and evaluating biometric data. This additional user authentication enables the security of the system or method to be further enhanced, since for example if the terminal device is lost or stolen, access to communications services remains prohibited due to this additional user authentication—assuming a third party cannot meet the requirements of this authentication. Based on the additional user authentication, access to content that is appropriate only for adults also remains prohibited in the event a child uses the terminal device of his parents.

Security can be further enhanced by the use of cryptographic mechanisms, such that, for example, the verification entity is provided with a digital signature so as to ensure that the message is not manipulated and has actually been generated by the verification entity.

Two embodiments of the method or system according to the invention are shown in the figures and are described below. Therein:

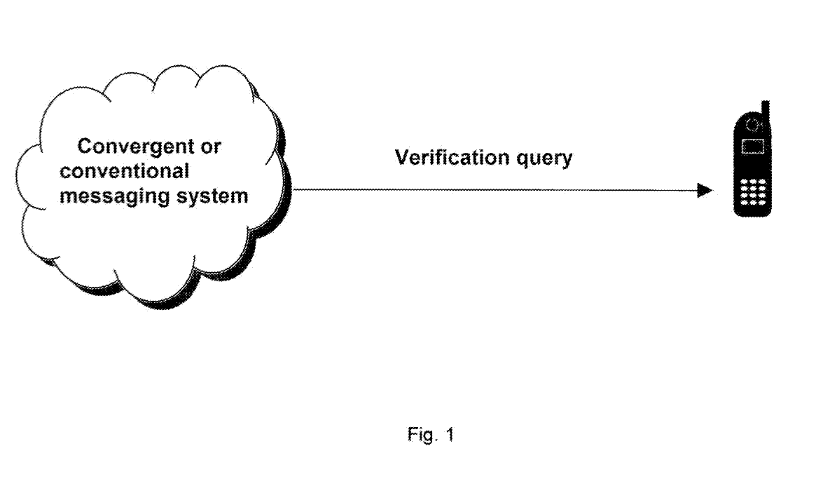

FIG. 1 is a schematic view of communications service and mobile phone terminal device when accessing the communications service;

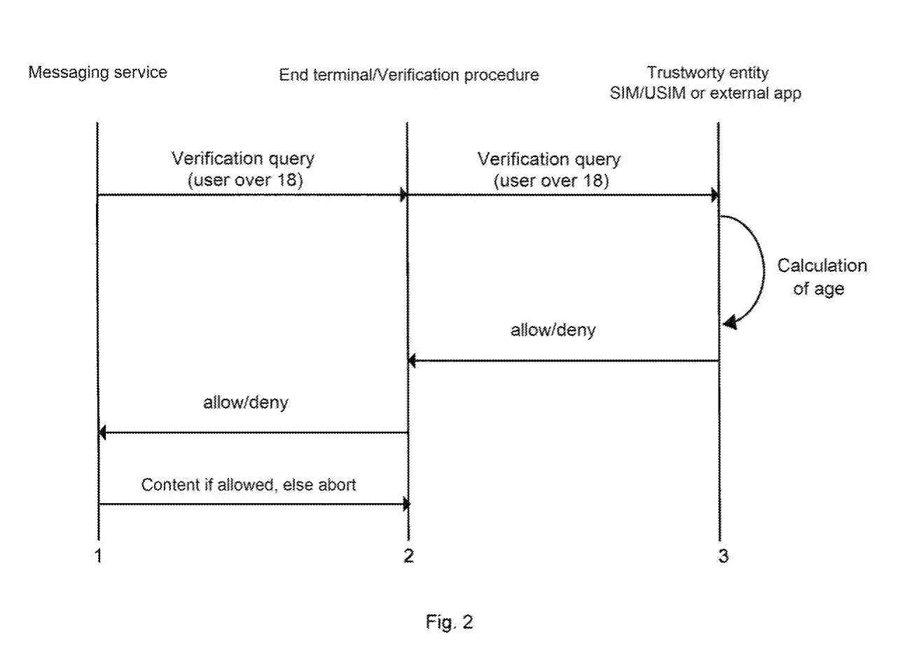

FIG. 2 is a flow chart illustrating a first embodiment of the method according to the invention;

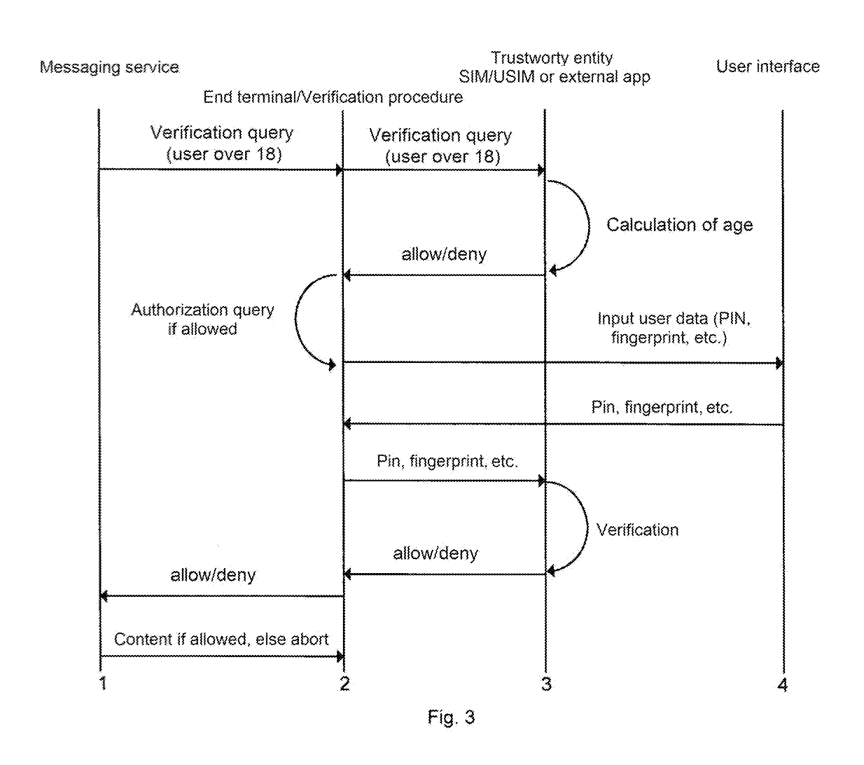

FIG. 3 is a flow chart illustrating a second embodiment of the method according to the invention.

The fundamental idea of the invention is based on establishing a protocol element (with appropriate parameters) in the message exchange between communications services 1, which element initiates a verification process in the terminal device 2 of the user, as shown in FIG. 1. The terminal device can be, as shown in FIG. 1, a mobile phone terminal device; however, it can also be a terminal device for fixed-network communication (a PC, for example). The present invention is in principle applicable to communications services within any desired communications network having stationary and mobile terminal devices.

When this protocol element reaches the terminal device 2 of the user, a verification procedure is initiated that initiates a request to a “trustworthy entity” 3. This “trustworthy entity” 3 can be the SIM/USIM of the user's terminal device 2, or an external application outside the terminal device 2 (e.g. an application on an “authorization server”) or an application located in a protected area of the terminal device 2.

The protocol element is parameterized according to the invention such that the response that is sent back to the messaging service 1 can assume only two values—allow/deny. FIG. 2 illustrates this process, by way of example, based on an age verification.

When a given service 1 is accessed by a user using the terminal device 2, a verification query is automatically generated by the service 1 and transmitted to the user terminal device 2. As a result of this request (verification query), a verification procedure is initiated that relays the request (verification query) to the verification entity 3, specifically to the trustworthy entity 3 located internally or externally of the terminal device 2, which entity implements a verification of the use authorization by calculating the age of the user of the communications service 1 in the example shown in FIG. 2.

After calculating the age of the user based on the data available to the trustworthy entity 3, the verification entity 3 generates an appropriate message relating to the use authorization (allow/deny) and sends this message back to the terminal device 2, which in turn relays this message (allow/deny) to the selected service 1. If access to the communications service 1 is authorized according to the message (allow/deny), this service 1 provides the desired content and transmits it to the user terminal device 2; otherwise no data is released (content if allowed, else abort).

This process ensures that no confidential or personal information is sent back to the requesting entity 1. In order to ensure the above-described procedure takes place, appropriate user data (the birth date of the user, in the above example) must be stored in the “trustworthy entity” 3. The “trustworthy entity” 3 can be provided according to the invention with a digital signature in order to ensure that the response (allow/deny) has really been generated by the “trustworthy entity” 3.

Additional examples of verification queries are: creditworthiness, registered user, etc.

In messaging services 1 that operate with so-called notification processes, this messaging element can be immediately embedded in the notification, with the result that the content is loaded or the notification rejected depending on the result of the verification.

In another embodiment of the invention, provision is made whereby the user must undergo additional authorization, as is shown in the embodiment of FIG. 3.

This authorization can be done, for example, by entering a PIN or by requesting biometric data (fingerprint, etc.) or by an electronic identifier based on an appropriate technology, such as, for example RFID, that is incorporated in or reliably on the body.

In the second embodiment of FIG. 3, in response to the user's accessing a given service 1 by the terminal device 1, a verification query to the user terminal device 2 is again made automatically by the service 1. A verification procedure is initiated by this request (verification query) that relays the request (verification query) to the verification entity 3, specifically to the trustworthy entity 3 located internally in or externally of the terminal device, which entity does a verification of the use authorization by calculating the age of the user of the communications service 1 based on the data available to trustworthy entity 3.

After calculating the age of the user, the verification entity 3 generates an appropriate message relating to the use authorization (allow/deny) and transfers this message back to the terminal device 2, which generates the (allow/deny) message. If this message from the verification entity 3 in principle confirms this use authorization, an authentication procedure is initiated.

In this process, a further authentication of the user is implemented by appropriate readers via a user interface 4 by entering user data, for example, a personal identification number (PIN) or by collecting biometric data, such as for example a fingerprint. The collected data are relayed by the user interface 4 to the terminal device 2 that in turn feeds this data to the verification entity 3 for purposes of verification.

After the authentication data are verified by the verification entity 3, an appropriate message (allow/deny) is generated and transmitted through the terminal device 2 to the selected service 1, as shown in FIG. 3.

If the access to communications service 1 is authorized based on the message (allow/deny), this service 1 provides the desired content and transmits them to the terminal device 2, otherwise no release of data occurs (content if allow, else abort).

The highest security possible is thus ensured for access to communications service 1 by a user based on this two-stage examination by the trustworthy entity 3 of the use authorization.

This additional query by the user interface 4 enables the system to ensure that the current user of the terminal device 2 is in fact the user for whom the verification query has been initiated.

The limiting requirement that applies here is that the appropriate identification datum (biometric datum, PIN, etc) can be verified in the “trustworthy entity” 3 (SIM/USIM; or an application that is anchored in a secured area of the terminal device hardware; or an external application, etc.) due to the fact that the relevant data (PIN, cryptographic key, or the like) are stored there.

An elementary implementation of the second embodiment relating to age verification is represented by storing the birth date of the user on his SIM/USIM, the SIM/USIM being activated by entering a PIN known only to the user. The data needed for is verification are stored for this purpose on the SIM/USIM and are transmitted to the verification entity.

1. A method of verifying the use authorization of access to media content of a communications service usable via mobile telephone network or fixed telephone network by a corresponding terminal device (2), the method comprising the steps of:
generating a verification query by the communications service and transmitting the generated signal to the end terminal;
initiating by the end terminal a verification process that verifies the use authorization by means of a verification entity;
authenticating the user before or after verifying the use authorization by requesting a personal identification number or collecting and evaluating biometric data;
generating by means of the verification entity (3) an appropriate message after examining the use authorization; and
transmitting the appropriate message directly or indirectly to the communications service.

2. The method according to claim 1, wherein the verification entity verifies the use authorization by querying the SIM or the USIM of the terminal device.

3. The method according to claim 1, wherein the verification entity is located externally to the terminal device on an external data-processing system.

4. The method according to claim 1, wherein the verification entity is located in a protected area of the terminal device.

5. (canceled)

6. The method according to claim 1 wherein the message from the verification entity is cryptographically secured.
